(19) United States
(12) Patent Application Publication
(10) Pub. No.: US 2026/0233560 A1
(43) Pub. Date: Aug. 13, 2026

(54) TIRE

(71) Applicant: THE YOKOHAMA RUBBER CO., LTD., Kanagawa (JP)

(72) Inventor: Yosuke SAKAMOTO, Kanagawa (JP)

(21) Appl. No.: 19/155,069

(22) PCT Filed: Feb. 9, 2024
(86) PCT No.: PCT/JP2024/004563

§ 371 Date: Aug. 8, 2025

(30) Foreign Application Priority Data
Feb. 14, 2023 (JP) 2023-020736

(51) Int. Cl. B60C 11/03; B60C 11/13

(52) U.S. Cl. CPC B60C 11/0306; B60C 11/0302; B60C 2011/0346; B60C 2011/0367; B60C 2011/1361

(57) ABSTRACT

A block in a tire tread includes zigzag main grooves on both sides of an equator and extend in the circumferential direction, inclined bent grooves extend toward the equator from the zigzag main grooves, a narrow groove connects the inclined bent grooves on both sides of the equator, and at least one sipe. The inclined bent grooves include a first inclined portion extending toward the equator from the zigzag main grooves, inclined relative to the circumferential direction, and having a bend point, and a second inclined portion extending in the same direction as the first inclined portion, inclined toward a side in the circumferential direction from the first inclined portion, and terminating without crossing the tire equator. The narrow groove inclines opposite to the inclined bent grooves and connects intermediate portions of the second inclined portion.

### TECHNICAL FIELD

The present technology relates to a tire intended to run on unpaved roads and the like and particularly relates to a tire that can provide improved snow performance without impairing wear resistance.

### BACKGROUND ART

Tires intended to run on unpaved roads (such as irregular ground, muddy ground, sandy ground, and rocky areas) in addition to paved roads, such as all-terrain tires, need to have excellent off-road performance. These tires also need to have excellent snow performance to enable stable running during snowfall. In particular, snow performance has recently focused on among the above-described performances, and having sufficient performance even on snowy road surfaces in extremely severe cold regions is awaited. Such tires tend to employ a tread pattern composed mainly of lug grooves and blocks having many edge components, the tread pattern having a large groove area (see, for example, Japan Unexamined Patent Publication No. 2019-137218 A). On the other hand, block rigidity of a tread pattern having a large groove area tends to easily decrease, and thus measures to maintain sufficient wear resistance are also awaited. In view of the above, providing snow performance and wear resistance in a highly compatible manner is awaited.

### SUMMARY

The present technology provides a tire that can provide improved snow performance without impairing wear resistance.

A tire according to an embodiment of the present technology includes a tread portion extending in a tire circumferential direction and having an annular shape. The tread portion includes a plurality of blocks defined by a plurality of grooves. The plurality of grooves includes a pair of bent main grooves disposed on both sides of a tire equator and extending zigzag along the tire circumferential direction, a plurality of inclined bent grooves extending toward the tire equator from each of the pair of bent main grooves, and an inclined narrow groove connecting an inclined bent groove of the inclined bent grooves on one side of the tire equator and an inclined bent groove of the inclined bent grooves on the other side of the tire equator. Each of the inclined bent grooves is constituted by a first inclined groove portion extending toward the tire equator from the pair of bent main grooves and inclined with respect to the tire circumferential direction and a second inclined groove portion extending in the same direction as the first inclined groove portion and inclined toward a side in the tire circumferential direction from the first inclined groove portion. The first inclined groove portion has at least one bend point. The second inclined groove portion terminates without crossing the tire equator. The inclined narrow groove is inclined in a direction opposite to the inclined bent grooves and connects intermediate portions of the second inclined groove portion. At least one sipe is formed in each of the plurality of blocks.

In the tire according to an embodiment of the present technology, the block and each groove formed between a pair of bent main grooves have the above-described structure, and snow performance can thus be improved without impairing wear resistance. In particular, the number of the main grooves (bent main grooves) extending along the tire circumferential direction is a pair (two), block rigidity between the main grooves (center region) is thus ensured, and a wear resistance can be satisfactorily maintained. On the other hand, bending of the main groove (bent main groove) can exhibit good snow performance despite a pair (two) of the main grooves. Providing the inclined bent groove also can improve snow performance. However, the inclined bent groove (second inclined groove portion) terminates without crossing the tire equator, block rigidity is thus ensured, and wear resistance can be satisfactorily maintained. Furthermore, the inclined narrow groove that is inclined in a direction opposite to the inclined bent groove and connects the intermediate portions of the second inclined groove portions to each other allows inclined grooves to be disposed in various directions and can improve snow performance. In addition, at least one sipe being formed in each block can ensure an edge effect of the sipe and improve snow performance. Cooperation of the foregoing can provide wear resistance and snow performance in a highly compatible manner.

In an embodiment of the present technology, an inclination angle θ1 of the first inclined groove portion with respect to the tire circumferential direction preferably ranges from 50° to 85°, an inclination angle θ2 of the second inclined groove portion with respect to the tire circumferential direction preferably ranges from 5° to 40°, and a difference θ1−θ2 between the inclination angles θ1 and θ2 is preferably 30° or less and 80° or more. Setting the inclination angle of each portion in this manner provides a better shape of the inclined bent groove, advantageously improving snow performance.

In an embodiment of the present technology, a groove depth of an inclined bent groove preferably ranges from 50% to 100% of a groove depth of a bent main groove, and a groove depth of an inclined narrow groove preferably ranges from 60% to 100% of the groove depth of the inclined bent grooves. Setting the groove depth of each groove in this manner advantageously improves snow performance while ensuring block rigidity.

In an embodiment of the present technology, a length L1 of the first inclined groove portion and a length L2 of the second inclined groove portion preferably satisfy a relationship L2/L1≥1.7. This provides a better balance between the circumferential groove component and the width direction groove component provided by the inclined bent groove, advantageously improving snow performance.

In an embodiment of the present technology, the plurality of grooves preferably include a subsidiary inclined groove that communicates with the bent main groove and the second inclined groove portion and is inclined in the same direction as the first inclined groove portion. Including the subsidiary inclined groove in this manner causes a groove component to be added, advantageously improving snow performance.

In an embodiment of the present technology, the plurality of grooves preferably include a shoulder lug groove extending from the bent main groove toward the outer side in the tire width direction and, the number of bend points of the first inclined groove portion is defined as N1, the number of bend points of the second inclined groove portion is defined as N2, the number of bend points of the inclined narrow groove is defined as N3, the number of bend points of the shoulder lug grooves is defined as Ns, and the number of these bend points preferably satisfy a relationship Ns≤N2<N1≤N3. Such configuration provides a better bent shape of each groove and can improve, in addition to ensuring block rigidity (maintaining wear resistance) and improving an edge effect (improving snow performance), snow performance due to improvement of snow discharge performance.

In an embodiment of the present technology, the plurality of grooves preferably include a lateral connecting groove that connects the second inclined groove portion on one side of the tire equator and the second inclined groove portion on the other side of the tire equator at a side closer to a terminating end of the second inclined groove portion than the inclined narrow groove. Including the lateral connecting groove in this manner can ensure an edge effect of the groove, advantageously improving snow performance.

In an embodiment of the present technology, the plurality of grooves preferably include, on one side of the tire equator, a circumferential connecting groove that connects the second inclined groove portions adjacent to each other in the tire circumferential direction. Including the circumferential connecting groove in this manner can ensure an edge effect of the groove, advantageously improving snow performance.

An embodiment of the present technology preferably includes a protruding portion protruding from a groove bottom at an intersection point with at least one of the inclined bent grooves of the pair of bent main grooves. Providing a protruding portion in this manner can improve snow performance without affecting wear resistance.

The tire according to an embodiment of the present technology is preferably a pneumatic tire, but may be a non-pneumatic tire. In the case of a pneumatic tire, the interior thereof may be filled with air, an inert gas such as nitrogen, or another gas.

### BRIEF DESCRIPTION OF DRAWINGS

FIG. 1 is a meridian cross-sectional view of a tire according to an embodiment of the present technology.

FIG. 2 is a front view illustrating a tread surface of a tire according to an embodiment of the present technology.

FIG. 3 is an explanatory view illustrating an extracted part of FIG. 2.

### DETAILED DESCRIPTION

Configurations of embodiments of the present technology will be described in detail below with reference to the accompanying drawings.

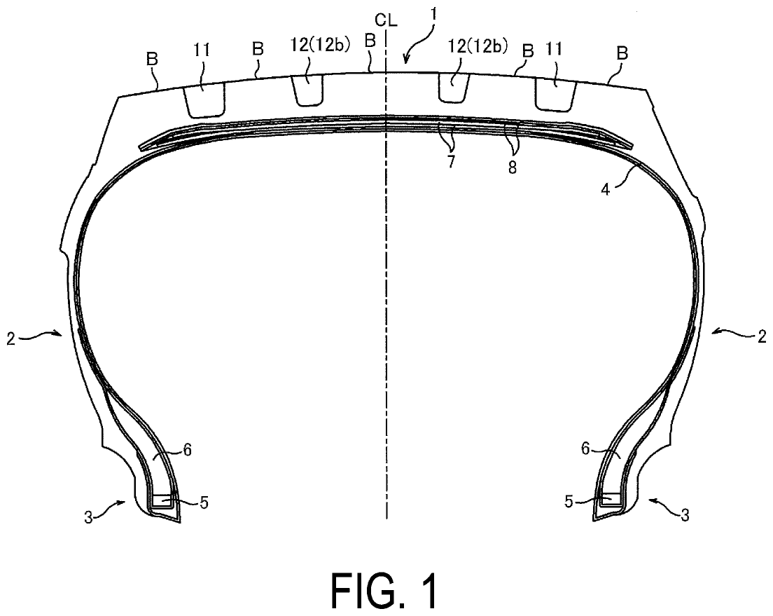

In a case of being a pneumatic tire as illustrated in FIG. 1, a tire according to an embodiment of the present technology includes a tread portion 1 that contacts a road surface, a pair of sidewall portions 2 disposed on both sides of the tread portion 1, and a pair of bead portions 3 disposed on an inner side of the sidewall portions 2 in the tire diameter direction. “CL” in FIG. 1 denotes a tire equator. Although not illustrated in FIG. 1, which is a meridian cross-sectional view, the tread portion 1, the sidewall portion 2, and the bead portion 3 each extend in the tire circumferential direction in an annular shape, thus forming a toroidal basic structure of the pneumatic tire. Hereinafter, although the description using FIG. 1 is basically based on the illustrated meridian cross-sectional shape, all of the tire components extend in the tire circumferential direction and form the annular shape.

A carcass layer 4 is disposed between the pair of left and right bead portions 3. The carcass layer 4 includes a plurality of reinforcing cords extending in the tire diameter direction, and is folded back around a bead core 5 disposed in each of the bead portions 3 from the inner side in the tire width direction to the outer side. A bead filler 6 is disposed on the periphery of the bead core 5, and the bead filler 6 is enveloped by a body portion and a folded back portion of the carcass layer 4. On the other hand, in the tread portion 1, a plurality of belt layers 7 (two layers in FIG. 1) are embedded on an outer circumferential side of the carcass layer 4. The belt layers 7 each include a plurality of reinforcing cords inclining with respect to the tire circumferential direction and are disposed such that the reinforcing cords of the different layers intersect each other. In these belt layers 7, the inclination angle of the reinforcing cords with respect to the tire circumferential direction is set in a range of, for example, from 10° to 40°. Furthermore, at least one layer (two layers in FIG. 1) of belt reinforcing layers 8 is provided on the outer circumferential side of the belt layers 7. The belt reinforcing layer 8 includes organic fiber cords oriented in the tire circumferential direction. In the belt reinforcing layer 8, the angle with respect to the tire circumferential direction in the organic fiber cord is set to 0° to 5°, for example.

The present technology relates to a tread pattern formed on the surface of the tread portion 1 of the tire as will be described below, and the basic structure (cross-sectional structure) of the tire is not limited to the general structure described above. The present technology can be applied to various types of tires including non-pneumatic tires as long as the tire has a surface (a portion corresponding to the surface of the tread portion 1 of a pneumatic tire) that contacts the road surface.

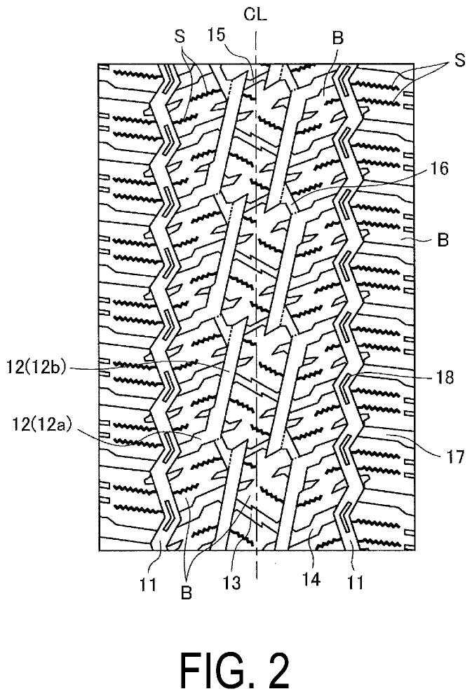

As illustrated in FIG. 2, the surface of the tread portion 1 of the tire according to an embodiment of the present technology has provided thereon a plurality of blocks B defined by a plurality of grooves. The plurality of grooves defining the plurality of blocks B necessarily include three types of grooves: a bent main groove 11, an inclined bent groove 12, and an inclined narrow groove 13, which will be described below. At least one sipe S is necessarily formed in each of the plurality of blocks B.

The bent main grooves 11 are grooves extending zigzag along the tire circumferential direction, and a pair (two) of the bent main grooves 11 are disposed on both sides of the tire equator. A zigzag shape is a shape in which a linear portion inclined in one direction with respect to the tire circumferential direction and a linear portion inclined in the other direction are arranged alternately in the tire circumferential direction. In the bent main groove 11, a point at which the linear portion inclined in one direction with respect to the tire circumferential direction and a linear portion inclined in the other direction are connected is referred to as a bend point. In the following description, a region between the pair of bent main grooves 11 may be referred to as a center region, and a region on the outer side of each bent main groove 11 in the tire width direction may be referred to as a shoulder region. The bent main groove 11 is a groove having the largest groove width and groove depth among the three types of grooves described above. Specifically, the groove width of the bent main groove 11 preferably ranges from 3 mm to 13 mm, and more preferably from 5 mm to 11 mm. The groove depth of the bent main groove 11 preferably ranges from 8 mm to 16 mm, and more preferably from 10 mm to 15 mm.

The inclined bent groove 12 is a groove extending from each of the pair of bent main grooves 11 toward the tire equator CL. A plurality of the inclined bent grooves 12 are provided at intervals in the tire circumferential direction. Particularly, in the illustrated example, the inclined bent groove 12 extend from a bend point of each bent main groove 11 on the inner side in the tire width direction. The inclined bent groove 12 is constituted by a first inclined groove portion 12a extending from the bent main groove 11 toward the tire equator CL in a manner inclined with respect to the tire circumferential direction, and a second inclined groove portion 12a extending in the same direction as the first inclined groove portion 12a and further inclined in the tire circumferential direction than the first inclined groove portion 12a. Connecting the first inclined groove portion 12a and the second inclined groove portion 12b results in that the inclined bent groove 12 has one bend point on one position as a whole, and the first inclined groove portion 12a additionally has a bend point on at least one position. One end of the second inclined groove portion 12b is connected to the first inclined groove portion 12a, and the other end terminates without crossing the tire equator CL. Specifically, although the other end of the second inclined groove portion 12b has a tapered shape in which the groove width converge toward the terminating end, and has an acute-angled tip (apex of the acute angle) at its termination position, the tip (apex) is disposed on one side of the tire equator CL (the side on which the inclined bent groove 12 to which the second inclined groove portion 12b belongs is provided), and the second inclined groove portion 12b does not intersect with the tire equator CL. The inclined bent groove 12 (the first inclined groove portion 12a and the second inclined groove portion 12b) is a groove whose groove width and groove depth are equal to or less than those of the bent main groove. The groove width of the inclined bent groove 12 preferably ranges from 80% to 97%, and more preferably from 85% to 95% of the groove width of the bent main groove 11. The groove depth of the inclined bent groove 12 preferably ranges from 50% to 100%, and more preferably from 70% to 100% of the groove depth of the bent main groove 11.

The inclined narrow groove 13 is a groove that connects the inclined bent groove 12 on one side of the tire equator CL and the inclined bent groove 12 on the other side of the tire equator CL. Therefore, the inclined narrow groove 13 necessarily intersects with the tire equator CL. The inclined narrow groove 13 is inclined in a direction opposite to the inclined bent groove 12 and connects intermediate portions of the second inclined groove portions 12b to each other. The inclined narrow groove 13 may be bent. In the illustrated example, the inclined narrow groove 13 is bent in a Z shape and has two bend points. The bent narrow groove 13 is a groove whose groove width and groove depth are smaller than those of the inclined bent groove 12. The groove width of the bent narrow groove 13 preferably ranges from 35% to 75%, and more preferably from 45% to 65% of the groove width of the inclined bent groove 12. The groove depth of the bent narrow groove 13 preferably ranges from 50% to 100%, and more preferably from 70% to 100% of the groove depth of the inclined bent groove 12.

At least one sipe S is provided in each block B as described above. In the illustrated example, each block B has provided therein two sipes S extending in a zigzag shape. The shape of the sipe S is not particularly limited, and various shapes such as a linear shape can be employed besides the illustrated zigzag shape. The number of the sipes S to be provided in each block B can be set as appropriate according to the size of the block, and preferably ranges from 1 to 4, and more preferably from 2 to 3. The sipe S is a fine groove having a groove width ranging, for example, from 0.5 mm to 2.0 mm and a groove depth ranging, for example, from 2 mm to 15 mm.

Providing various types of grooves as described above allows the tire according to an embodiment of the present technology to provide improved snow performance without impairing wear resistance. In other words, the number of the main grooves (bent main grooves 11) extending along the tire circumferential direction is a pair (two grooves), block rigidity between the main grooves (center region) is thus ensured, and wear resistance can be satisfactorily maintained. On the other hand, the main groove (the bent main groove 11) is bent and can thus exhibit good snow performance even when the number of the main grooves is only two (a pair). Providing the inclined bent groove 12 can also improve snow performance. However, the inclined bent groove 12 (second inclined groove portion 12b) terminates without crossing the tire equator CL, block rigidity is thus ensured, and wear resistance can be satisfactorily maintained. Furthermore, the inclined narrow groove 13 being inclined in a direction opposite to the inclined bent groove 12 and connecting the intermediate portions of the second inclined groove portions 12b to each other causes grooves inclined in various directions to be disposed and can improve snow performance. In addition, at least one sipe S being formed in each block B can ensure an edge effect of the sipe S to improve snow performance. Cooperation of the foregoing can provide wear resistance and snow performance in a highly compatible manner.

In a case where any of the above-described three types of grooves is not included, or when a groove is provided at a similar position but the bent shape, the inclination direction, and the like does not satisfy the above-described conditions, the above-described effect of each groove is insufficient, which makes it difficult to provide wear resistance and snow performance in a well-balanced and compatible manner. The groove width or the groove depth of each groove being smaller than the above-mentioned range fails to provide a sufficient groove volume and improve snow performance. On the other hand, the groove width or the groove depth of each groove being larger than the above-mentioned range increases the groove volume and fails to ensure block rigidity, making it difficult to sufficiently maintain wear resistance.

In the present technology, the plurality of grooves defining the plurality of blocks B preferably include, besides the above-described three types of grooves, a subsidiary inclined groove 14, a lateral connecting groove 15, and a circumferential connecting groove 16, which will be described below. Including the above-mentioned grooves causes groove components extending in various directions to be added and can thus ensure an edge effect of each groove, advantageously improving snow performance. The inclination direction, the groove width, and the groove depth of each groove are set as described below, block rigidity can thus be sufficiently ensured, and a wear resistance can be satisfactorily maintained even when each groove is added.

The subsidiary inclined groove 14 is a groove that communicates with the bent main groove 11 and the second inclined groove portion 12b, and is inclined in the same direction as the first inclined groove portion 12a. In the illustrated example, the subsidiary inclined groove 14 extends from a bend point to which the inclined bent groove 12 (first inclined groove portion 12a) is not connected among the bend points on the inner side in the tire width direction of each bent main groove 11. The subsidiary inclined groove 14 preferably has a bent shape similar to that of the first inclined groove portion 12a. The subsidiary inclined groove 14 is preferably connected to positions within 10% of the length of the second inclined groove portion 12b from the center of the second inclined groove portion 12b at both sides in the tire circumferential direction. The subsidiary inclined groove 14 preferably has a groove width and a groove depth equal to or less than those of the inclined bent groove 12. Specifically, the groove width of the subsidiary inclined groove 14 preferably ranges from 50% to 100%, and more preferably from 65% to 85% of the groove width of the inclined bent groove 12. The groove depth of the subsidiary inclined groove 14 preferably ranges from 50% to 100%, and more preferably from 70% to 100% of the groove depth of the inclined bent groove 12.

The lateral connecting groove 15 is a groove that connects the second inclined groove portion 12b on one side of the tire equator CL and the second inclined groove portion 12b on the other side of the tire equator at a side closer to the terminating end of the second inclined groove portion 12b than the inclined narrow groove 13. However, the lateral connecting groove 15 is connected to a position away from the tip (apex) of the second inclined groove portion 12b, and a tip (apex) is necessarily present at the terminating end of the second inclined groove portion 12b. The lateral connecting groove 15 is preferably inclined in a direction opposite to the inclined narrow groove 13. The lateral connecting groove 15 has a groove depth equal to or less than that of the inclined bent groove 12 (second inclined groove portion 12b). Specifically, the groove depth of the lateral connecting groove 15 preferably ranges from 70% to 100%, and more preferably 75% to 100% of the groove depth of the inclined bent groove 12. On the other hand, the lateral connecting groove 15 has a groove width which is sufficiently smaller than that of the inclined bent groove 12 (second inclined groove portion 12b). Specifically, the groove width of the lateral connecting grooves 15 preferably ranges from 20% to 60%, and more preferably from 30% to 50% of the groove widths of the inclined bent groove 12b. The groove width of the lateral connecting groove 15 is significantly smaller than the groove width of the inclined bent groove 12 (second inclined groove portion 12b) in this manner, and the inclined bent groove 12 (second inclined groove portion 12b) is thus considered to terminate even when the lateral connecting groove 15 is connected to the terminating end side (near the tip) of the second inclined groove portion 12b.

The circumferential direction connecting groove 16 is a groove that connects the second inclined groove portions 12b adjacent to each other on one side of the tire equator CL in the tire circumferential direction. In the illustrated example, the circumferential connecting groove 16 connects the end portion of one of the second inclined groove portions 12b on the side of the first inclined groove portion 12a and the terminating end (near the tip) of the second inclined groove portion 12b adjacent to the one of the second inclined groove portions 12b. The circumferential connecting groove 16 is preferably inclined in a direction opposite to the second inclined groove portion 12b. Note that the circumferential connecting groove 16 is connected to a position away from the tip (apex) of the second inclined groove portion 12b, and a tip (apex) is necessarily present at the terminating end of the second inclined groove portion 12b. The circumferential connecting groove 16 has a groove depth equal to or less than that of the inclined bent groove 12 (second inclined groove portion 12b). Specifically, the groove depth of the circumferential connecting groove 16 preferably ranges from 80% to 100%, and more preferably from 90% to 100% of the groove depth of the inclined bent groove 12. On the other hand, the circumferential connecting groove 16 has a groove width which is sufficiently smaller than that of the inclined bent groove 12 (second inclined groove portion 12b). Specifically, the groove width of the circumferential connecting groove 16 preferably ranges from 40% to 90%, and more preferably from 55% to 75% of the groove width of the inclined bent groove 12. The groove width of the circumferential connecting grooves 16 is significantly smaller than the groove width of the inclined bent grooves 12 (second inclined groove portions 12b) in this manner, and the inclined bent groove 12 (second inclined groove portions 12b) is thus considered to terminate even when the circumferential connecting groove 16 is connected to the terminal side (near the tip) of the second inclined groove portion 12b.

Note that although the structure of the shoulder region is not particularly limited, there is preferably provided a shoulder lug groove 17 extending from the bent main groove 11 toward the outer side in the tire width direction. A plurality of the shoulder lug grooves 17 are preferably disposed at intervals in the tire circumferential direction. In the illustrated example, the shoulder lug grooves 17 are connected to a bend point of each bent main groove 11 on the outer side in the tire width direction. The groove width of the shoulder lug groove 17 preferably ranges from 70% to 98%, and more preferably from 80% to 95% of the groove width of the bent main groove 11. The groove depth of the shoulder lug groove 17 preferably ranges from 75% to 100%, and more preferably from 80% to 98% of the groove depth of the bent main groove.

As described above, in the present technology, the plurality of grooves that define the plurality of blocks B necessarily include the inclined bent groove 12 (the first inclined groove portion 12a and the second inclined groove portion 12b) and the inclined narrow groove 13. Among the grooves (groove portions), at least the first inclined groove portion 12a and the inclined narrow groove 13 are necessarily bent, and the second inclined groove portion 12b may also optionally be bent. On this occasion, letting N1 be the number of bend points of the first inclined groove portion 12a, N2 be the number of bend points of the second inclined groove portion 12b, and N3 be the number of bend points of the inclined narrow groove 13, the numbers of the bend points preferably satisfy a relationship N2<N1≤N3. For example, in the illustrated example, the number N1 of the bend points of the first inclined groove portion 12a is 2, the number N2 of the bend points of the second inclined groove portion 12b is 0, and the number N3 of the bend points of the inclined narrow groove 13 is 2, satisfying the above-described size relationship. Such configuration provides a better bent shape of each groove and can improve, in addition to ensuring block rigidity (maintaining wear resistance) and improving an edge effect (improving snow performance), snow performance due to improvement of snow discharge performance. Note that letting Ns be the number of bend points of the shoulder lug groove 17 in a case where the shoulder lug groove 17 is provided, the numbers of bend points preferably satisfy a relationship Ns≤N2≤N1≤N3. Although the numbers of bend points of each groove is not particularly limited to any specific numbers, the number N1 of bend points of the first inclined groove portion 12a preferably ranges from 2 to 3, the number N2 of bend points of the second inclined groove portion 12b preferably ranges from 0 to 2, the number N3 of bend points of the inclined narrow groove 13 preferably ranges from 2 to 4, and the number Ns of bend points of the shoulder lug groove 17 preferably ranges from 0 to 1.

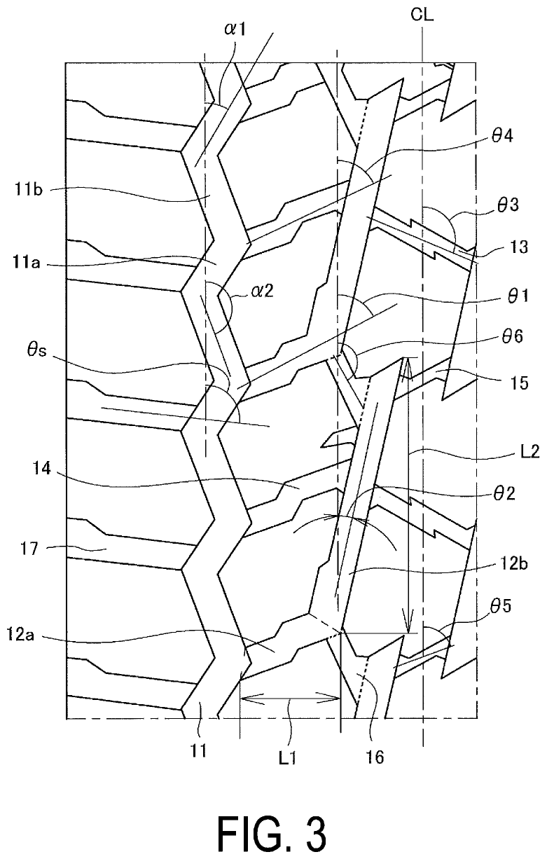

Although the various types of grooves described above are all inclined with respect to the tire circumferential direction, it is preferable to set the inclination angle of each groove with respect to the tire circumferential direction as described below. Note that the inclination angle of each groove is assumed to be measured based on the center line of each groove, as illustrated in FIG. 3. In a case where the groove is bent, an angle formed with respect to the tire circumferential direction by a straight line connecting together the groove width centers at the end portions of the groove is defined as the inclination angle. FIG. 3, illustrating an extracted part of FIG. 2, illustrates main grooves (the bent main groove 11, the inclined bent groove 12, the inclined narrow groove 13, the subsidiary inclined groove 14, the lateral connecting groove 15, the circumferential connecting groove 16, and the shoulder lug groove 17) in an extracted manner, omitting the sipe S, the cutout, and also a protruding portion 18 described below.

The inclination angle θ1 of the first inclined groove portion 12a with respect to the tire circumferential direction preferably ranges from 50° to 85°, and more preferably from 60° to 80°. This can provide a groove component extending in the tire width direction, advantageously improving traction performance on snow-covered road surfaces. The inclination angle θ1 being smaller than 50° decreases an edge effect. When the inclination angle θ1 exceeds 85°, steering stability on snow-covered road surfaces decreases. The inclination angle θ2 of the second inclined groove portion side 12b with respect to the tire circumferential direction preferably ranges from 5° to 40°, and more preferably from 8° to 30°. This can provide a groove component extending in the tire circumferential direction, advantageously improving steering stability on snow-covered road surfaces. The inclination angle θ2 being smaller than 5° decreases an edge effect. When the inclination angle θ2 exceeds 40°, steering stability on snow-covered road surfaces decreases. The difference θ1−θ2 between the inclination angles θ1 and θ2 is preferably 30° or more and 80° or less, and more preferably 40° or more and 70° or less. Setting the difference between the inclination angles in this manner provides a better bent shape of the entire inclined bent groove 12 and a better balance between the traction performance and the steering stability on the snow-covered road surface, and snow performance can thus be effectively improved. The inclination angle difference θ1−θ2 being smaller than 30° decreases an edge effect. When the inclination angle difference θ1−θ2 exceeds 80°, an edge effect decreases.

An inclination angle θ3 of the inclined narrow groove 13 with respect to the tire circumferential direction preferably ranges from 90° to 135°, and more preferably from 110° to 130°. This advantageously improving snow performance and wear resistance (block rigidity) in a well-balanced manner. When the inclination angle θ3 exceeds 135°, an edge effect decreases. The inclination angle θ3 being smaller than 90° decreases wear resistance (block rigidity). Inclination angles of other grooves are not particularly limited, but an inclination angle θ4 of the subsidiary inclined groove 14 with respect to the tire circumferential direction can be set in a range of, for example, 60° to 80°, an inclination angle θ5 of the lateral connecting groove 15 with respect to the tire circumferential direction can be set in a range of, for example, 50° to 75°, and an inclination angle θ6 of the circumferential connecting groove 16 with respect to the tire circumferential direction can be set in a range of, for example, 110° to 130°. When providing the shoulder lug groove 17, its inclination angle θs with respect to the tire circumferential direction can be set to, for example, 90° to 120°.

The bent main groove 11 has a shape in which a linear portion inclined in one direction with respect to the tire circumferential direction and a linear portion inclined in the other direction are arranged alternately in the tire circumferential direction, as described above. In other words, the bent main groove 11 is constituted by a linear portion (hereinafter referred to as a first linear portion 11a) inclined in the same direction as the inclined bent groove 12 and a linear portion (hereinafter referred to as a second linear portion 11b) inclined in a direction opposite to the inclined bent groove 12. Letting α1 be the inclination angle of the first linear portion 11a with respect to the tire circumferential direction, and α2 be the inclination angle of the second linear portion 11b with respect to the tire circumferential direction, the inclination angle α1 can be set in a range of, for example, 10° to 60°, and the inclination angle α2 can be set in a range of, for example, 85° to 145°.

In constituting the inclined bent groove 12 by using the first inclined groove portion 12a and the second inclined groove portion 12b, making a length of the second inclined groove portion 12b sufficiently larger length than that of the first inclined groove portion 12a can provide a groove component extending in the tire circumferential direction, advantageously improving steering stability on snow-covered road surfaces. In particular, the length L1 of the first inclined groove portion 12a and the length L2 of the second inclined groove portion 12b preferably satisfy a relationship L2/L1≥1.7, and more preferably a relationship 2.0≤L2/L1≤3.0. A relationship L2/L1<1.7 cannot have a sufficiently long length of the second inclined groove portion 12b and fails to sufficiently exhibit the effect of improving steering stability on snow-covered road surfaces. Note that, as illustrated in FIG. 3, the length L1 is a length measured along the tire width direction, and the length L2 is a length measured along the tire circumferential direction.

A protrusion 18 protruding from a groove bottom may also be provided at an intersection with the inclined bent groove 12 of at least one of the pair of bent main grooves 11. Providing the protruding portion 18 in this manner can enhance an on-snow edge effect without affecting wear resistance, improving snow performance. The protrusion height of the protruding portion 18 from the groove bottom preferably ranges from 2% to 20%, and more preferably from 5% to 15% of the groove depth of the bent main groove 11. The protruding portion 18 may not be one that the entire width of the groove bottom of the bent main groove 11 protrudes, but may be one having a shape in which a part thereof protrudes. In particular, the width of the protruding portion 18 preferably ranges from 10% to 50%, and more preferably from 10% to 30% of the groove width of the bent main groove 11. Note that, when providing the protruding portion 18, the protruding portion 18 is preferably provided at a position away from a point at which the shoulder lug groove 17 connects to the bent main groove 11 so as not to hinder snow discharge effect from the bent main groove 11 toward the shoulder lug groove 17.

The present technology will further be described below by way of Examples, but the scope of the present technology is not limited to the Examples.

### Examples

There were manufactured 13 types of pneumatic tires described in a conventional example 1, comparative examples 1 and 2, and examples 1 to 15 having a tire size of LT265/70R17 121/118S and the basic structure (cross-sectional structure) illustrated in FIG. 1, the shape of the main groove, the presence of the inclined bent groove, the number of bend points of the first inclined groove portion, the termination position of the second inclined groove portion, the inclination direction of the inclined narrow groove, the presence of the sipe, the inclination angle θ1 of the first inclined groove portion with respect to the tire circumferential direction, the inclination angle θ2 of the second inclined groove portion with respect to the tire circumferential direction, the difference θ1−θ2 between the inclination angles, the groove depth of the inclined bent groove, the groove depth of the inclined narrow groove, the ratio L2/L1 of the lengths of the first inclined groove portion and the second inclined groove portion, the relationship between the number of bends N1 to N3 and Ns, and the presence of the protruding portion are set in Tables 1 and 2, based on the tread pattern of FIG. 2.

In Table 1, “Shape of main groove” column indicates “Straight line” in a case where the main groove extends linearly, and “Bent” in a case where the main groove extends zigzag. “Termination position of second inclined groove portion” column indicates “Not reach equator” in a case where the second inclined groove portion terminates without reaching the tire equator, and “Reach equator” in a case where the second inclined groove portion reaches the tire equator or extends beyond the tire equator. “Inclination direction inclined narrow groove” column indicates “Same direction” in a case where the inclined narrow groove is inclined in the same direction as the inclined bent groove and “Opposite direction” in a case where the inclined narrow groove is inclined in the opposite direction. “Groove depth of inclined bent groove” column indicates the value of the ratio (unit: %) of the groove depth of the inclined bent groove relative to the groove depth of the bent main groove. “Groove depth of inclined narrow groove” column indicates the value of the ratio (unit: %) of the groove depth of the inclined narrow groove relative to the groove depth of the inclined bent groove. “Relationship of number of bending times” column indicates “Compliant” in a case where the number N1 of bend points of the first inclined groove portion, the number N2 of bend points of the second inclined groove portion, the number N3 of bend points of the inclined narrow groove portion, and the number Ns of bend points of the shoulder lug groove satisfy a relationship Ns≤N2<N1≤N3 and “Not compliant” in a case where they do not satisfy the relationship.

The pneumatic tires were evaluated in terms of snow performance and wear resistance using an evaluation method described below, the results of which are indicated together in Tables 1 and 2.

### Snow Performance

Respective test tires were assembled on wheels having a rim size of 17×8J and mounted on a test vehicle (traction test vehicle) with air pressure of front tires set 450 kPa and air pressure of rear tires set to 550 kPa, and sensory evaluation of traction characteristics (startability) was performed by a test driver on a test course including snow-covered road surfaces. Evaluation results are expressed as index values with Conventional Example 1 being assigned the index value of 100. The larger index values mean excellent snow performance.

### Wear Resistance

Respective test tires were mounted on wheels having a rim size of 17×8J and mounted on a test vehicle (four wheel drive SUV) with air pressure of front tires set 450 kPa and air pressure of rear tires set to 550 kPa, and a running test was performed by a test driver on a test course to calculate an estimated wear life from an amount of wear after having run 8000 km. Evaluation results are expressed as index values with Conventional Example 1 being assigned the index value of 100. A larger index value indicates a longer running distance before being completely worn out and means better wear resistance.

TABLE 1

| | | Conventional | Comparative | | Comparative |
|---|---|---|---|---|---|
| | | Example 1 | Example 1 | Example 1 | Example 2 |
| Shape of main groove | | Straight line | Bent | Bent | Bent |
| Presence of inclined bent groove | | No | Yes | Yes | Yes |
| Number of bend points of first | | — | 0 | 2 | 2 |
| inclined groove portion | | | | | |
| Termination position of second | | Reaching | Reaching | Not | Not |
| inclined groove | | equator | equator | reaching | reaching |
| | | | | equator | equator |
| Inclination direction of inclined | | — | Same | Opposite | Same |
| narrow groove | | | direction | direction | direction |
| Presence of sipe | | Yes | Yes | Yes | Yes |
| Inclination angle θ1 | ° | 60 | 50 | 68 | 68 |
| Inclination angle θ2 | ° | 60 | 40 | 10 | 10 |
| Difference θ1 − θ2 | ° | 0 | 10 | 58 | 58 |
| Groove depth of inclined bent groove | % | — | 88 | 88 | 88 |
| Groove depth of inclined narrow | % | — | 70 | 70 | 70 |
| groove | | | | | |
| Ratio L2/L1 | | — | 1 | 3 | 3 |
| Relationship of numbers of bends | | — | Not | Compliant | Compliant |
| | | | compliant | | |
| Presence of protrusion portion | | No | No | Yes | Yes |
| Snow performance | Index | 100 | 102 | 110 | 108 |
| | value | | | | |
| Wear resistance | Index | 100 | 97 | 102 | 101 |
| | value | | | | |

| | | Example | Example | Example | Example | Example |
|---|---|---|---|---|---|---|
| | | 2 | 3 | 4 | 5 | 6 |
| Shape of main groove | | Bent | Bent | Bent | Bent | Bent |
| Presence of inclined bent groove | | Yes | Yes | Yes | Yes | Yes |
| Number of bend points of first | | 2 | 2 | 2 | 2 | 2 |
| inclined groove portion | | | | | | |
| Termination position of second | | Not | Not | Not | Not | Not |
| inclined groove | | reaching | reaching | reaching | reaching | reaching |
| | | equator | equator | equator | equator | equator |
| Inclination direction of inclined | | Opposite | Opposite | Opposite | Opposite | Opposite |
| narrow groove | | direction | direction | direction | direction | direction |
| Presence of sipe | | Yes | Yes | Yes | Yes | Yes |
| Inclination angle θ1 | ° | 50 | 85 | 68 | 70 | 60 |
| Inclination angle θ2 | ° | 10 | 10 | 5 | 40 | 30 |
| Difference θ1 − θ2 | ° | 40 | 75 | 63 | 30 | 30 |
| Groove depth of inclined bent | % | 88 | 88 | 88 | 88 | 88 |
| groove | | | | | | |
| Groove depth of inclined narrow | % | 70 | 70 | 70 | 70 | 70 |
| groove | | | | | | |
| Ratio L2/L1 | | 3 | 3 | 3 | 3 | 3 |
| Relationship of numbers of bends | | Compliant | Compliant | Compliant | Compliant | Compliant |
| Presence of protrusion portion | | Yes | Yes | Yes | Yes | Yes |
| Snow performance | Index | 111 | 112 | 111 | 112 | 111 |
| | value | | | | | |
| Wear resistance | Index | 104 | 103 | 104 | 103 | 104 |
| | value | | | | | |

TABLE 2

| | | Example | Example | Example | Example | Example |
|---|---|---|---|---|---|---|
| | | 7 | 8 | 9 | 10 | 11 |
| Shape of main groove | | Bent | Bent | Bent | Bent | Bent |
| Presence of inclined bent groove | | Yes | Yes | Yes | Yes | Yes |
| Number of bend points of first | | 2 | 2 | 2 | 2 | 2 |
| inclined groove portion | | | | | | |
| Termination position of second | | Not | Not | Not | Not | Not |
| inclined groove | | reaching | reaching | reaching | reaching | reaching |
| | | equator | equator | equator | equator | equator |
| Inclination direction of | | Opposite | Opposite | Opposite | Opposite | Opposite |
| inclined narrow groove | | direction | direction | direction | direction | direction |
| Presence of sipe | | Yes | Yes | Yes | Yes | Yes |
| Inclination angle θ1 | ° | 85 | 68 | 68 | 68 | 68 |
| Inclination angle θ2 | ° | 5 | 10 | 10 | 10 | 10 |
| Difference θ1 − θ2 | ° | 80 | 58 | 58 | 58 | 58 |
| Groove depth of inclined bent | % | 88 | 50 | 100 | 88 | 88 |
| groove | | | | | | |
| Groove depth of inclined narrow | % | 70 | 70 | 70 | 60 | 100 |
| groove | | | | | | |
| Ratio L2/L1 | | 3 | 3 | 3 | 3 | 3 |
| Relationship of numbers of bends | | Compliant | Compliant | Compliant | Compliant | Compliant |
| Presence/absence of protrusion portion | | Yes | Yes | Yes | Yes | Yes |
| Snow performance | Index | 112 | 111 | 112 | 111 | 112 |
| | value | | | | | |
| Wear resistance | Index | 103 | 104 | 103 | 104 | 103 |
| | value | | | | | |

| | | Example | Example | Example | Example |
|---|---|---|---|---|---|
| | | 12 | 13 | 14 | 15 |
| Shape of main groove | | Bent | Bent | Bent | Bent |
| Presence of inclined bent groove | | Yes | Yes | Yes | Yes |
| Number of bend points of first | | 2 | 2 | 2 | 2 |
| inclined groove portion | | | | | |
| Termination position of second | | Not | Not | Not | Not |
| inclined groove | | reaching | reaching | reaching | reaching |
| | | equator | equator | equator | equator |
| Inclination direction of | | Opposite | Opposite | Opposite | Opposite |
| inclined narrow groove | | direction | direction | direction | direction |
| Presence of sipe | | Yes | Yes | Yes | Yes |
| Inclination angle θ1 | ° | 68 | 68 | 68 | 68 |
| Inclination angle θ2 | ° | 10 | 10 | 10 | 10 |
| Difference θ1 − θ2 | ° | 58 | 58 | 58 | 58 |
| Groove depth of inclined bent | % | 88 | 88 | 88 | 88 |
| groove | | | | | |
| Groove depth of inclined narrow | % | 70 | 70 | 70 | 70 |
| groove | | | | | |
| Ratio L2/L1 | | 1.5 | 2 | 3 | 3 |
| Relationship of numbers of bends | | Compliant | Compliant | Not compliant | Compliant |
| Presence/absence of protrusion portion | | Yes | Yes | Yes | NO |
| Snow performance | Index | 111 | 112 | 111 | 112 |
| | value | | | | |
| Wear resistance | Index | 104 | 103 | 104 | 103 |
| | value | | | | |

As is apparent from Tables 1 and 2, the pneumatic tires of examples 1 to 15 provided improved snow performance and wear resistance compared to those of conventional example 1, providing these performances in a well-balanced and compatible manner. On the other hand, Comparative Example 1 had reduced wear resistance because the second inclined groove portion extended beyond the equator and did not obtain sufficient snow performance. Comparative Example 2 had a reduced edge effect because the inclined narrow groove was inclined in the same direction as the inclined bent groove and did not obtain sufficient snow performance.

1. A tire comprising a tread portion extending in a tire circumferential direction and having an annular shape,
the tread portion comprising a plurality of blocks defined by a plurality of grooves,
the plurality of grooves comprising a pair of bent main grooves disposed on both sides of a tire equator and extending zigzag along the tire circumferential direction, a plurality of inclined bent grooves extending toward the tire equator from each of the pair of bent main grooves, and an inclined narrow groove connecting an inclined bent groove of the inclined bent grooves on one side of the tire equator and an inclined bent groove of the inclined bent grooves on the other side of the tire equator,
each of the inclined bent grooves being constituted by a first inclined groove portion extending toward the tire equator from the pair of bent main grooves and inclined with respect to the tire circumferential direction and a second inclined groove portion extending in the same direction as the first inclined groove portion and inclined toward a side in the tire circumferential direction from the first inclined groove portion, the first inclined groove portion having at least one bend point, the second inclined groove portion terminating without crossing the tire equator,
the inclined narrow groove being inclined in a direction opposite to the inclined bent grooves and connecting intermediate portions of the second inclined groove portion, and
at least one sipe being formed in each of the plurality of blocks.

2. The tire according to claim 1, wherein
an inclination angle θ1 of the first inclined groove portion with respect to the tire circumferential direction ranges from 50° to 85°,
an inclination angle θ2 of the second inclined groove portion with respect to the tire circumferential direction ranges from 5° to 40°, and
a difference θ1−θ2 between the inclination angles θ1 and θ2 is 30° or more and 80° or less.

3. The tire according to claim 1, wherein
a groove depth of the inclined bent groove ranges from 50% to 100% of a groove depth of the bent main grooves, and
a groove depth of the inclined narrow groove ranges from 60% to 100% of the groove depth of the inclined bent grooves.

4. The tire according to claim 1, wherein a length L1 of the first inclined groove portion and a length L2 of the second inclined groove portion satisfy a relationship L2/L1≥1.7.

5. The tire according to claim 1, wherein the plurality of grooves comprise a subsidiary inclined groove that communicates with the bent main groove and the second inclined groove portion and is inclined in the same direction as the first inclined groove portion.

6. The tire according to claim 1, wherein
the plurality of grooves comprise a shoulder lug groove extending from the bent main groove toward an outer side in a tire width direction,
the number of bend points of the first inclined groove portion is defined as N1,
the number of bend points of the second inclined groove portion is defined as N2,
the number of bend points of the inclined narrow groove is defined as N3,
the number of bend points of the shoulder lug grooves is defined as Ns, and
the number of these bend points satisfies a relationship Ns≤N2<N1≤N3.

7. The tire according to claim 1, wherein the plurality of grooves comprise a lateral connecting groove that connects the second inclined groove portion on one side of the tire equator and the second inclined groove portion on the other side of the tire equator at a side closer to a terminating end of the second inclined groove portion than the inclined narrow groove.

8. The tire according to claim 1, wherein the plurality of grooves comprise, on one side of the tire equator, a circumferential connecting groove that connects the second inclined groove portions adjacent to each other in the tire circumferential direction.

9. The tire according to claim 1, comprising a protruding portion protruding from a groove bottom at an intersection point with at least one of the inclined bent grooves of the pair of bent main grooves.

10. The tire according to claim 2, wherein
a groove depth of the inclined bent groove ranges from 50% to 100% of a groove depth of the bent main grooves, and
a groove depth of the inclined narrow groove ranges from 60% to 100% of the groove depth of the inclined bent grooves.

11. The tire according to claim 10, wherein a length L1 of the first inclined groove portion and a length L2 of the second inclined groove portion satisfy a relationship L2/L1≥1.7.

12. The tire according to claim 11, wherein the plurality of grooves comprise a subsidiary inclined groove that communicates with the bent main groove and the second inclined groove portion and is inclined in the same direction as the first inclined groove portion.

13. The tire according to claim 12, wherein
the plurality of grooves comprise a shoulder lug groove extending from the bent main groove toward an outer side in a tire width direction,
the number of bend points of the first inclined groove portion is defined as N1,
the number of bend points of the second inclined groove portion is defined as N2,
the number of bend points of the inclined narrow groove is defined as N3,
the number of bend points of the shoulder lug grooves is defined as Ns, and
the number of these bend points satisfies a relationship Ns≤N2<N1≤N3.

14. The tire according to claim 13, wherein the plurality of grooves comprise a lateral connecting groove that connects the second inclined groove portion on one side of the tire equator and the second inclined groove portion on the other side of the tire equator at a side closer to a terminating end of the second inclined groove portion than the inclined narrow groove.

15. The tire according to claim 14, wherein the plurality of grooves comprise, on one side of the tire equator, a circumferential connecting groove that connects the second inclined groove portions adjacent to each other in the tire circumferential direction.

16. The tire according to claim 15, comprising a protruding portion protruding from a groove bottom at an intersection point with at least one of the inclined bent grooves of the pair of bent main grooves.
